(19) United States
(12) Patent Application Publication
(10) Pub. No.: US 2008/0313310 A1
(43) Pub. Date: Dec. 18, 2008

(54) Method for Distributing Programs over a Communication Network

(75) Inventors: Yojak Harshad Vasa, Cary, NC (US); William O. Camp, JR., Chapel Hill, NC (US); Charles Liu, Chapel Hill, NC (US); Anthony J. Sammarco, Raleigh, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/768,971

(22) Filed: Jun. 27, 2007

Related U.S. Application Data
(60) Provisional application No. 60/944,253, filed on Jun. 15, 2007.

(51) Int. Cl. G06F 15/16

(52) U.S. Cl. 709/219

(57) ABSTRACT

A method of distributing programs enables distribution of programs on demand to end devices in a communication network to enable communication between first and second end devices. A data object server stores programs that are needed for communication between first and second end devices. The programs are associated by the data object server with a device class. The first and second end devices can send data object requests to the data object server to request an program associated with a particular device class. In response to the data object request, the data object server sends a control program associated with the specified device to one of the first and second end devices.

### RELATED APPLICATION

This application claims the benefit of U.S. Provisional Patent Application 60/944,253, filed Jun. 15, 2007, which is incorporated herein by reference.

### BACKGROUND

The present invention relates generally to a system and method for distributing computer programs and other executable data objects over a communication network on demand to enable communications and interactions between end devices.

The introduction of enhanced data capabilities for wireless networks has resulted in an explosion of wireless applications for users of mobile devices such as cell phones, Personal Digital Assistants (PDAs), laptop computers, etc. Mobile device users are now able to browse web pages, compose and read e-mail messages, chat with their friends and acquaintances, download music and/or video files from Internet servers, and send digital photographs or images to their friend. Additionally, mobile devices can be used to control devices that are accessible via the Internet.

A program resident on a first communication device may wish to communicate with a program on another communication device. The communication devices may comprise mobiles device or devices having a fixed connection to the network. In order for the two programs to communicate, the programs must use the same protocols to exchange information. If one program requires a particular protocol that is not present on the other communication device, then the communication may not be possible. In this situation, it would be desirable to have a method to enable one or both of the communication devices to obtain on demand the necessary protocols and programs for communication between the end devices.

### SUMMARY

The present invention provides and method of distributing programs on demand to enable communication between first and second end devices in a communication network. A data object server stores programs that are needed for communication between first and second end devices. The programs are associated by the data object server with a device class. The first and second end devices can send data object requests to the data object server to request a program associated with a particular device class. In response to the data object request, the data object server sends a communication program associated with the specified device class to one of the first and second end devices.

In one exemplary embodiment, a first end device initiates communications with a second end device. The second end device sends a data object request to the data object server. The data object request includes at least the device class of the second end device. The data object server selects a communication program corresponding to the device class of the second device and sends the communication program to the first end device. Alternatively, the data object server may send the communication program to the second device, which then forwards the communication program to the first end device. The originating device loads the communication program into memory and executes the communication program to enable communication with the second end device.

In another exemplary embodiment, a control program enabling a first end device to control a second device is stored in a data object server. When the first end device initiates communications with a second end device, the second end device sends a data object request to the data object server. The data object request includes at least the device class of the second end device. The data object server selects a control program corresponding to the device class of the second end device and sends the control program to the first end device. Alternatively, the data object server may send the control program to the second device, which then forwards the control program to the first end device. The first end device loads the control program into memory and executes the control program to control the second end device.

### BRIEF DESCRIPTION OF THE DRAWINGS

FIG. 1 illustrates an exemplary communication network.

FIG. 2 illustrates an exemplary end device with a user interface.

FIG. 3 illustrates an exemplary end device without a user interface.

FIG. 4 illustrates an exemplary data object server.

FIG. 5 is a call flow diagram illustrating an exemplary push method for distributing programs on demand to end devices

FIG. 6 is a call flow diagram illustrating an exemplary pull method for distributing programs on demand to end devices.

FIG. 7 illustrates an exemplary lookup table used by the data object server to associate programs with device classes.

FIG. 8 illustrates an exemplary lookup table with a multi-filed index used by the data object server to associate programs with device classes.

### DETAILED DESCRIPTION

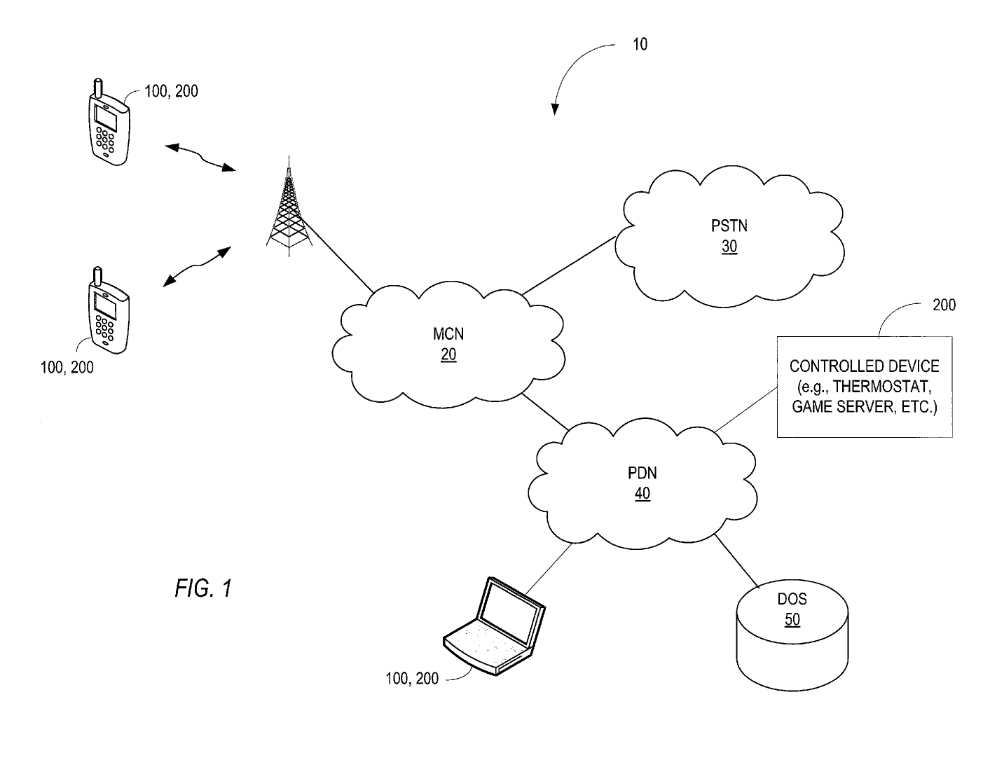

FIG. 1 illustrates a communication network 10 according to one exemplary embodiment of the invention. The communication network 10 comprises a conventional mobile communication network 20, Public Switched Telephone Network (PSTN) 30, and a packet data network 40. The mobile communication network 20 includes one or more base stations 22 for communicating with mobile devices 100 and provides voice and data services to mobile devices 100. The mobile communication network 20 interconnects with the Public Switched Telephone network (PSTN) 30 for voice services and with the PDN 40 for data services. The mobile communication network 20 may comprise for example a GSM, GPRS, EDGE, cdmaOne, cdma2000, WCDMA, or UMTS network, although other access technologies can also be used. The PDN 40 may comprise any public or private network based on Internet Protocols. It may comprise a wide area network, or a local area network. The Internet is one example of a wide area packet data network.

One or more end devices 100, 200 are connected to the communication network 10. The end devices 100, 200 may comprises any type of communication devices, such as desktop or laptop computers, cellular telephones, Personal Digital Assistants (PDAs), smart phones, that are capable of communicating over a communications network. As will be described below, the end devices 100, 200 may be broadly categorized as originating devices 100 and terminating devices 200. Originating devices 100 are end devices that originate calls or other communication sessions with terminating devices 200. Some end devices may function as both an originating device 100 and terminating device 200.

A data object server (DOS) 50 connected to the PDN 40 stores communication programs for communicating with or controlling end devices 100, 200. As used herein, the term program refers to a set of instructions that when executed cause a computer to perform specific operations. A communication program is a program that is used to facilitate communications between end devices 100, 200. For example, a communications program may be used to encode/decode data, encrypt/decrypt data, or compress/decompress data. A control program is a special case of a communication program that is used to send control commands over a communication network.

When an originating device 100 establishes a connection with the terminating device 200, the data object server 50 is contacted and forwards a corresponding program to the originating device 100 for communicating with or controlling the terminating device 200. The originating device 100 loads the program in its memory and executes the program to communicate with or control the terminating device 200. In this way, it is not necessary for the originating device 100 to permanently store the programs in its memory needed for communicating with or controlling all terminating devices 200. Further, the programs can be updated regularly at the DOS 50, so that the originating device 100 can be assured of getting the most up-to-date program for communication with or control of the terminating device 200.

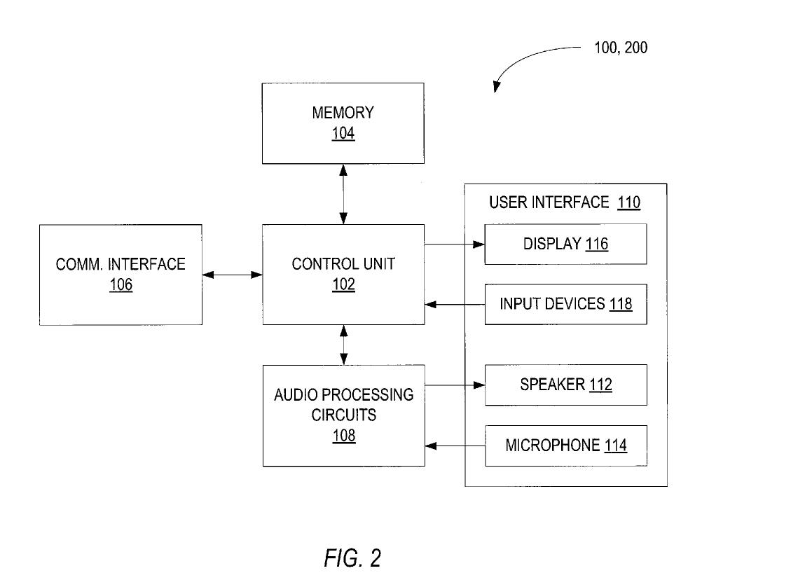

FIG. 2 illustrates the main components of an exemplary end device 100, 200 that may function as either an originating device 100 or terminating device 200. The end device 100 comprises a control unit 102, memory 104, transceiver 106, audio processing circuits 108, and a user interface 114. Control unit 102 may comprise one or more processors, hardware circuits, firmware, or a combination thereof, that control the overall operation of the end device 100, 200 according to program instructions stored in memory 106. Memory 104 may comprise one or more memory devices, including random access memory for temporary storage and read only memory for permanent storage. Communication interface 106 comprise a standard wired or wireless interface. For mobile devices, the communications interface may comprises a cellular transceiver operating according to any known standards, such a GSM, CDMA, WCDMA, etc., or a short-range wireless interface, such as a BLUETOOTH or WIFI transceiver. For fixed devices, the communications interface may comprise an Ethernet interface, cable modem, DSL modem etc. Audio processing circuits 108 process audio signals input via microphone 110 and output via speaker 112. Microphone 110 converts acoustic signals to electrical audio signals. Speaker 112 converts electrical audio signals into acoustic signals. A user interface 114 enables user interaction with the mobile device. The user interface 116 includes a display 116 for outputting information for viewing by the user and one or more input devices indicated generally by numeral 118 for receiving user input. Input devices 118 may, for example, comprise a keypad, touchpad, scroll wheel, joystick, push buttons, etc. Further, the display 116 may comprise a touch sensitive display for receiving user input.

In some embodiments, the terminating device 200, may not require a user interface 116, audio processing circuits 108, or other elements normally required in a communication device. For example, the terminating device 200 may comprise a thermostat, camera, machinery, appliance, or other piece of equipment that can be remotely controlled with an originating device 100. In this case, the terminating device 200 may be remotely accessed via the communication network 10 and controlled by the originating device 100. As an example, the terminating device may comprise a thermostat that can be accessed via the Internet and controlled from a mobile handheld device, such as a cellular telephone.

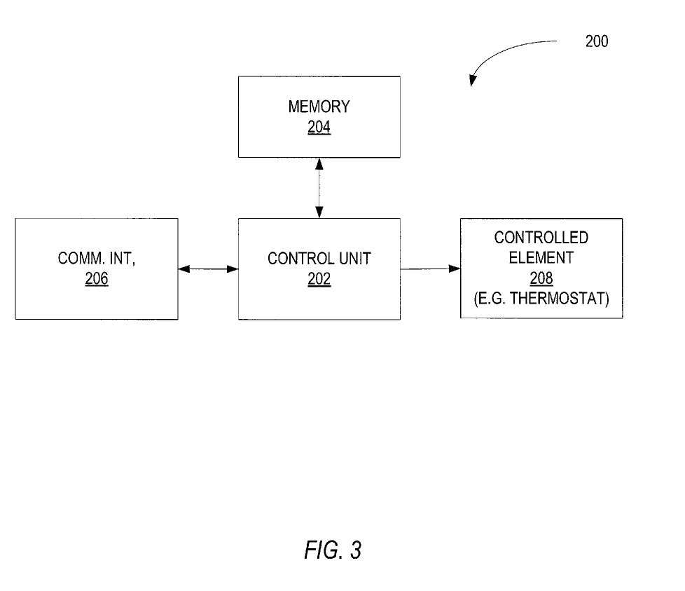

FIG. 3 illustrates an exemplary terminating device 200 for remote control programs. The terminating device 200 comprises a control unit 202, memory 204, and communication interface 206. The control unit 202 controls the operation of the terminating device 200. Memory 204 stores programs and data needed for operation. Communication interface 206, such as an Ethernet interface or cable modem connects the terminating device 200 to the PDN 40. The terminating device 200 further includes a controlled element 208, such as a thermostat, camera, machinery, or other equipment that is being remotely controlled with an originating device 100.

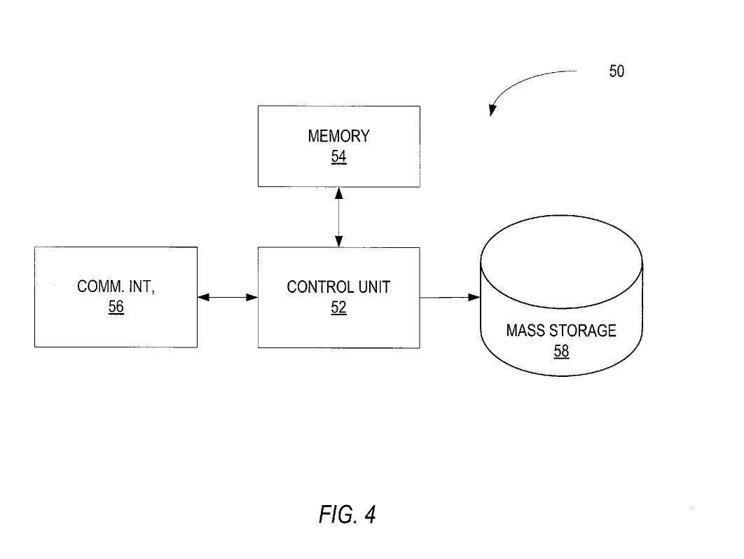

FIG. 4 illustrates an exemplary data object server 50. The main function of the data object server 50 is to store programs needed for communications between an originating device 100 and a terminating device 200. The data object server 50 comprises a control unit 52, memory 54, communication interface 56, and mass storage device 58. The control unit 52 controls the operation of the data object server 50. Memory 54 includes both volatile and non-volatile memory devices for storing programs and data used by the control unit 52. A portion of memory 54 may be dedicated to cache memory for storing recently or frequently accessed data objects. Communications interface 56 allows the control unit 52 to communicate with end devices 100, 200 over a communication network. The communications interface 56 may, for example, comprises an Ethernet interface for connecting to an IP network. Mass storage device 58 stores as a database containing programs for end devices 100, 200. Such programs may include, for example, communication programs for enabling communication between end devices 100, 200 and/or control programs to remotely control the terminating devices in remote control programs.

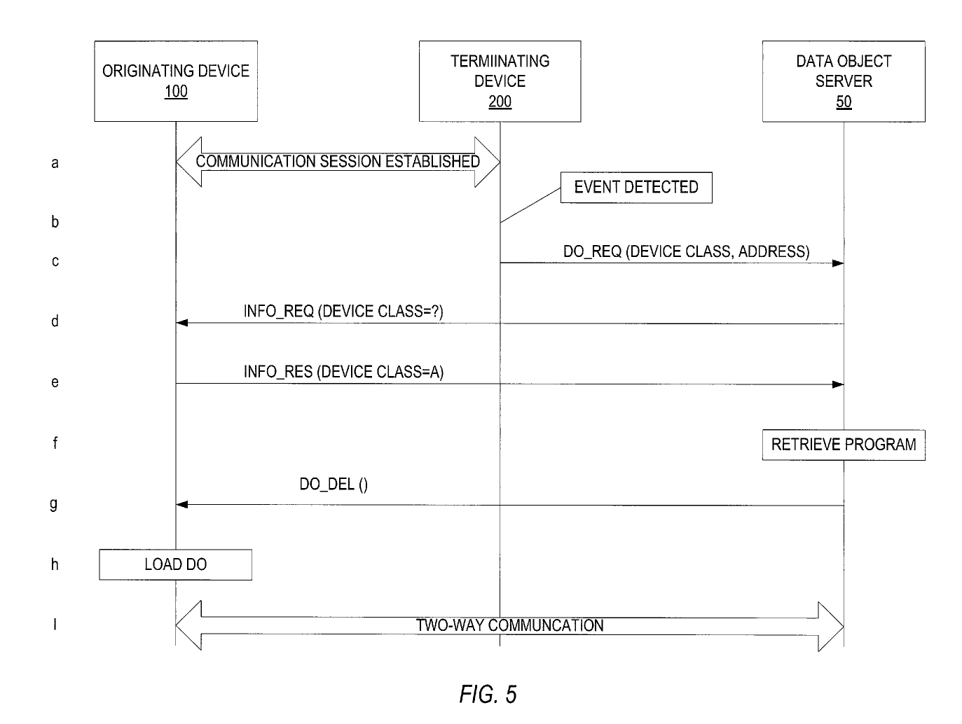

FIG. 5 illustrates an exemplary push method for distributing programs stored by the data object server 50. In this embodiment, the originating device 100 initiates a communication session with the terminating device 200. Data objects needed for communication between the originating and terminating devices 100, 200 are pushed to the originating device 100. A communication session is established between the originating and terminating devices 100, 200 (step a). Communications can be initiated, for example, using a standard session control protocol, such as the Session Initiation Protocol (SIP). In response to the initiation of a communication session, the terminating device 200 detects a triggering event (step b) and sends a data object request to the data object server 50 in response to the triggering event (step c). The triggering event may occur during the session establishment process, or during the session after it is established. The data object request includes at least the device class of the terminating device 200 and may further include the address and/or device class of the originating device 100 and preferably the address of the originating device.

In some embodiments, the data object server 50 may send an information request to the originating device 100 to obtain the device class of the originating device 100 (step d). When the originating device 100 receives an information request from the data object server, it may send an information response with the requested information to the data object server 50 (step e). Based on the device class of the terminating device 200 and/or the device class of the originating device 100, the data object server accesses its database and retrieves a program for use in communicating with or controlling the terminating device 200 (step f). The program may, for example, comprise a Java applet or code module that is installed at the originating device 100. If the device class of the originating device 100 is not provided in the data object request, the data object server 50 may send a generic control program to the originating device 100.

The data object server 50 sends the selected program to the originating device 100 based on the address provided in the data object request (step g). Alternatively, the data object server 50 could send the program to the terminating device 200 for forwarding to the originating device 100. After receiving the control program from the data object server 50, the originating device 100 loads the program into its memory (step h). The program adds functionality to the originating device 100 that is need for communicating with the terminating device 200. The originating device 100 can execute the program to control or communicate with the terminating device 200 (step i). It should be noted, that only one program or one set of programs needs to be stored by the data object server 50 for terminating devices 200 in the same device class.

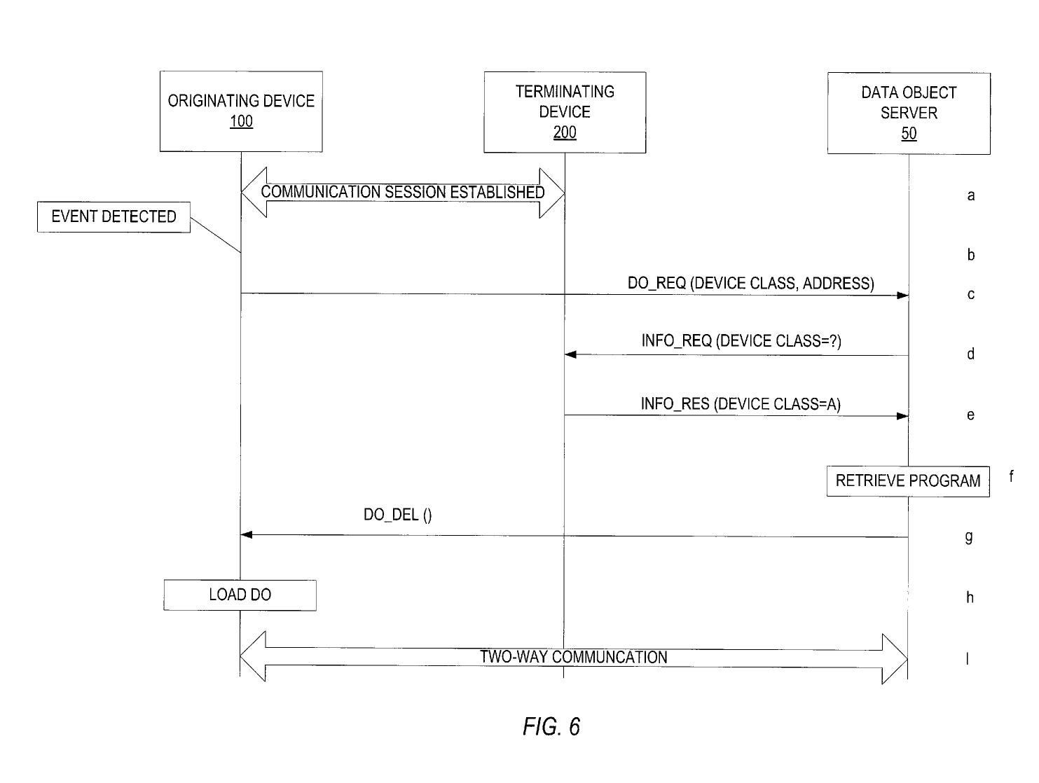

FIG. 6 illustrates an exemplary pull method for distributing programs stored by the data object server 50. In this embodiment, the originating device 100 initiates a communication session with the terminating device 200. Data objects needed for communication between the originating and terminating devices 100, 200 are pulled by the originating device 100 from the data object server 50. A communication session is established between the originating and terminating devices 100, 200 (step a). Communications can be initiated, for example, using a standard session control protocol, such as the Session Initiation Protocol (SIP). In response to the initiation of a communication session, the originating device 100 detects a triggering event (step b) and sends a data object request to the data object server 50 in response to the triggering event (step c). The triggering event may occur during the session establishment process, or during the session after it is established. The data object request includes at least the address of the terminating device 100. and may further include the device class of originating device 100.

In response to the data object request, the data object server 50 sends an information request to the terminating device 200 to obtain the device class of the originating device 100 (step d). When the terminating device 200 receives an information request from the data object server 50, it may send an information response with the requested information to the data object server 50 (step e). Based on the device class of the terminating device 200 and/or the device class of the originating device 100, the data object server 50 accesses its database and retrieves a program for use in communicating with or controlling the terminating device 200 (step f). The program may, for example, comprise a Java applet or code module that is installed at the originating device 100. If the device class of the originating device 100 is not provided in the data object request, the data object server 50 may send a generic control program to the originating device 100.

The data object server 50 sends the selected program to the originating device 100 based on the address provided in the data object request (step g). After receiving the control program from the data object server 50, the originating device 100 loads the program into its memory (step h). The program adds functionality to the originating device 100 that is need for communicating with or controlling the terminating device 200. The originating device 100 can execute the program to control or communicate with the terminating device 200 (step i). It should be noted, that only one program or one set of programs needs to be stored by the data object server 50 for terminating devices 200 in the same device class.

For control programs, the data object server 50 may send the originating device 100 a control program including code for controlling the terminating device 200, as well as a user interface for display to the user on the display of the originating device 100. If the device class of the originating device is known, a control program can be selected having a user interface adapted for the device class of the originating device 100. This ability to send a device-specific control program to the originating device is particularly useful for mobile devices that often have small displays and limited user controls. After the control program is loaded, the user of the originating device 100 can execute the control program to control the operation of the terminating device 200. When the communication session between the originating device 100 and terminating device 200 is established, the originating device 100 can send requests to and receive responses from the terminating device 200.

For communication programs, the data object server 50 may send the originating device 100 a Java applet or code module for processing information that is transferred between the originating device 100 and terminating device 200. For example, the code module may comprise an audio or video codec, encoder/decoder, cryptographic algorithm, digital rights management (DRM) method, compression/decompression algorithm, etc. Upon installing the code module, the originating device 100 can use the code module for communications with the terminating device.

The exemplary methods shown in FIGS. 5 and 6 show how a program can be pushed or pulled to the originating device 100 to add functionality to the originating device 100 for communications with the terminating device 200. The same technique can be applied to push or pull programs to the terminating device 200 needed to communicate with the originating device 100.

Referring now to the data object server 50, each program stored by the data object server 50 is associated with a device class for at least the terminating device 200 (or originating device 100). Programs may also be associated with a device class for the originating device 100 (or terminating device 200). As previously noted, the data object request received by the data object server 50 includes at least the device class of the terminating device 200 (or originating device 100). The device class of the originating device 100 can be provided in the data object request or in a response to an information request. The data object server 50 uses the device class provided in the data object request to select a corresponding program from its database. The selected program is then forwarded to the originating device 100.

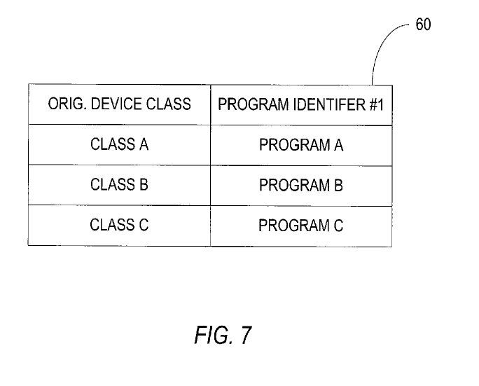

The data object server 50 may, for example, use a lookup table 60 to store the associations between device classes and corresponding programs. FIG. 7 illustrates an exemplary lookup table 60. The lookup table 60 comprises a plurality of columns that correspond to different fields of the lookup table 60. The first column of the lookup table 60 corresponds to the device class field and contains the device classes associated with programs stored by the data object server 50. The device class field of the lookup table is used as an index to the lookup table. The second column of the lookup table 60 is a program field to store identifiers for programs corresponding to each device class. In the embodiment shown in FIG. 6, each row of the lookup table corresponds to one device class. When a data object request is received, the data object server 50 finds the matching entry in the lookup table by comparing the device class provided in the data object request to the values in the device class field of the lookup table 60. If a matching value is found, the corresponding program is retrieved from memory and forwarded to the device initiating the communication.

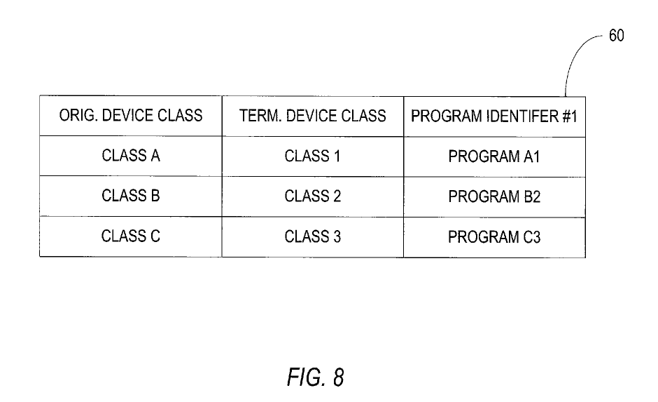

FIG. 8 illustrates an exemplary lookup table with a composite index. In this embodiment, the lookup table includes a multi-field index comprising the device class of the terminating device 200 and the device class of the originating device 100. The values stored in the two index fields form a unique composite index for each row in the lookup table. The lookup table further includes a program field containing program identifiers of programs corresponding to each unique composite index. Each row of the lookup table 60 corresponds to one composite index value. When a data object request is received, the data object server 50 finds the matching entry in the lookup table by comparing the device class provided in the data object request to the values in the device class field of the lookup table 60. As previously noted, the device class of the terminating device 200 is provided in the data object request. The data object server 50 may need to send an information request to the originating device 100 in order to get the device class for the originating device 100. If a matching composite index value is found, the corresponding program is retrieved from memory and forwarded to the originating device 100.

Those skilled in the art will appreciate that more than one type of program can be associated with each device class or composite in the lookup table 60. Further, the index for the lookup table 60 may comprise other fields in addition to the device class of the originating and terminating devices 100, 200 respectively. For example, assume that the data object server 50 stores code modules for different types of media sessions. In this case, the index to the lookup table 60 may include a field to indicate a media type (e.g., video, audio, etc.) for a communication session. Thus, the data object server can select the appropriate code module depending on the media type of the communication session.

The following examples illustrate exemplary embodiments of the present invention, which are intended to be illustrative and not limiting.

### EXAMPLE 1

Assume that the terminating device 200 comprises a thermostat that is accessible from a remote location via the Internet. In this example, the mobile device is acting as the originating device 100. The data object server 50 may store a control program including a graphical user interface and code for changing the settings or programming of the thermostat, for obtaining readings from the thermostat, and for diagnosing problems with the thermostat. The thermostat is assigned an address, which may be an IP address. A user can initiate a communication session with the thermostat from the mobile device in order to change the current settings or obtain current readings from the thermostat. For example, a communication session can be initiated using SIP by sending a SIP INVITE message from the originating device 100 to the thermostat. The SIP INVITE message includes the SIP address of the originating device 100. The When the communication session is initiated, the thermostat sends a data object request to the data object server 50 responsive to receipt of the session initiation request or other triggering event. The data object request includes the address of the mobile device provided in the session initiation request and the device class of the thermostat. The data object server forwards the control program for the thermostat to the originating device 100. The mobile device can then load and execute the control program to interact with the thermostat. The user of the mobile device can change the settings or current program of the thermostat, can obtain temperature measurements from the thermostat, or diagnose problems with the thermostat.

### EXAMPLE 2

User of a mobile device (i.e., the originating device 100) wants to connect to a game server (i.e., the terminating device 200) to play a game that the user recently learned about. The data object server 50 stores game programs and that can be used to play interactive games on the game server. The game program may include code for creating game characters and controlling game play. When the user of the mobile device initiates a connection to the game server, the game server sends a data object request to the data object server 50 in response to the session initiation request or other triggering event. The data object request includes the device class of the game server and the address of the mobile device provided in the session initiation request. If the game server is used for multiple games, the data object request may further include an indication of the game that the user of the mobile device wants to play. The data object server 50 forwards a game program for interacting with the game server 50 to the mobile device. The mobile device can then load and execute the game program to interact with the game server. In some embodiments, the game server may send an information request to the mobile device to identify the device class of the mobile device. In this case, the game server can use the device class returned by the mobile device to select a corresponding game program that is adapted for use with the user's mobile device.

### EXAMPLE 3

User of a first end device (e.g. a mobile device) wants to exchange information (e.g. audio and/or video files) with the user of second end device. When the user of first end device initiates a connection with second end device, the session initiation request (e.g. SIP INVITE) indicates a particular type of media session that is desired. For the requested media session, second end device requires a particular codec for the communication that is not present in First end device. The data object server 50 stores codecs that are used by second end device for various types of media sessions. When second end device receives the session initiation request from first end device, it sends a data object request including the device class for second end device and the address of first end device to the data object server 50. The data object request further includes type of media session requested. The data object server 50 sends the required codec for the requested media session to the first device that is required by second end device.

The first end device can then install the codec to enable exchange of audio/video information with second end device.

### EXAMPLE 4

User of a first end device wants to communicate with the user of second end device. The user of second end device desires that communications be secure. The data object server 50 stores encryption algorithms that are used by second end device for secure communications. When second end device receives a session initiation request from first end device, it sends a data object request including the device class for second end device and the address of first end device to the data object server 50. The data object request may further include an indication that secure communication is desired. The data object server 50 sends the required cryptographic algorithms to first end device. The first end device can then install the cryptographic algorithms to enable secure communication with second end device. It should be noted that the user of second end device may periodically change the cryptographic algorithms to thwart attempts to crack the cryptographic codes by statistical methods.

### EXAMPLE 5

The user of a first end device wants to exchange information (e.g. Audio and/or video files) with the user of Second end device. The audio video files are protected by digital rights management (DRM). The data object server 50 stores DRM methods used by second end device for various file types. When second end device receives the session initiation request from first end device, it sends a data object request including the device class for second end device and the address of the first end device to the data object server 50. The data object server 50 sends the required DRM methods to the first end device that is required to unlock or use files transferred from Second end device to the first end device. For example, the DRM methods may allow the user of the first end device to play the content a predetermined number of times, or may require the user of the first end device to purchase the content before use.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. In a communication system including a first end device, a second end device, and a data object server, a method of distributing a control program for the second end device to the first end device, the method comprising:
initiating a communication session between the first and second end devices; and
receiving a communication program at said first end device from a data object server responsive to initiation of the communication session, said communication program for communicating with the second end device.

2. The method of claim 1 wherein said second end device is a device of a particular device class and wherein the communication program provided by said data object server corresponds to the device class of the second end device.

3. The method of claim 1 further comprising sending information from said first end device to said second end device identifying a device class of the first end device; and
wherein said communication program provided by said data object server corresponds to said device class of said first end device.

4. The method of claim 1 further comprising:
receiving an information request at said first end device from said data object server to identify the device class of the first end device;
sending a response from the first end device to the data object server, said response including the device class of the first end device; and
wherein said communication program provided by said data object server corresponds to said device class of said first end device.

5. The method of claim 1 wherein the communication program comprises one of an encoding/decoding program, cryptographic program; compression/decompression program; and digital rights management program.

6. The method of claim 1 wherein the communication program comprises a control program for controlling the second end device.

7. The method of claim 6 further including loading the control program into memory of the first end device; and executing the control program on the first end device to control the second end device.

8. The method of claim 7 wherein the second end device comprises a game server, and wherein the control program comprises a game program to interact with the game server to control a game executing on the game server.

9. The method of claim 8 wherein the game program includes code for controlling game objects using the controls specific to the first end device.

10. In a communication system including a first end device, a second end device, and a data object server, a method of distributing a communication program for the second end device to the first end device, the method comprising:
detecting a triggering event at said second end device;
sending a data object request from said second end device to initiate the transfer of a communication program for the second end device stored by the data object server to the first end device.

11. The method of claim 10 wherein said data object request includes a device class of said second end device.

12. The method of claim 11 wherein said data object request further includes a device class of said first end device.

13. The method of claim 10 further comprising receiving said communication program at said second end device from said data object server, and forwarding said communication program to said first end device.

14. The method of claim 10 wherein data object request includes an address of said first end device so that the data object server can send the communication program to the first end device.

15. The method of claim 10 wherein communication program comprises one of an encoding/decoding program, cryptographic program; compression/decompression program; and digital rights management program.

16. The method of claim 10 wherein the communication program comprise a control program for controlling the second end device.

17. The method of claim 16 wherein the second end device comprises a game server and wherein the control program comprises a game program to interact with the game server to control a game executing on the game server.

18. In a communication system including a first end device, a second end device, and a data object server, a method of distributing a communication program for the second end device to the first end device, the method comprising:
storing a communication program for the second end device at said data object server;
receiving a data object request at said data object server from one of said first and second end devices;
in response to said data object request, sending the communication program for said second end device from said data object server to one of said first and second end devices.

19. The method of claim 18 wherein the data object request includes a device class for the second end device, and wherein the communication program is selected based on the device class of the second end device.

20. The method of claim 19 wherein the data object server further receives the device class of the first end device from one of said first and second end devices, and wherein the communication program is selected based on the device class of both the first and second end devices.

21. The method of claim 18 wherein communication program comprises one of an encoding/decoding program, cryptographic program; compression/decompression program; and digital rights management program.

22. The method of claim 18 wherein the communication program comprises a control program for controlling the second end device.

23. The method of claim 22 wherein the second end device comprises a game server and wherein the control program comprises a game program to interact with the game server to control a game executing on the game server.

24. In a communication system including a first end device, a second end device, and a data object server, a method of distributing a communication program for the second end device to the first end device, the method comprising:
initiating a communication session between the first and second end devices;
detecting a triggering event associated with the communication session;
in response to the detection of the triggering event, sending a data object request to the data object server;
transferring a communication program from said data object server to said first end device responsive to the data object request;
loading the control program into memory of the first end device; and
executing the communication program on the first end device to control the second end device.

25. The method of claim 24 wherein the second end device detects the triggering event and transmits the data object request to the data object server.

26. The method of claim 25 wherein the data object request includes the device class of the second end device and wherein the data object server selects a communication program based on the device class of the second end device.

27. The method of claim 26 wherein the data object request further includes the address of the first end device and wherein the data object transmits the communication program directly to the first end device at the address specified in the data object request.

28. The method of claim 27 further including sending an information request from said data object server to said first end device requesting the device class of the first end device, and sending a response from the first end device to the data object server including the device class of the first end device, wherein the data object server selects a communication program for transmission to the first end device based on the device class of both the first and second end devices.

29. The method of claim 24 wherein the first end device detects the triggering event and transmits the data object request to the data object server.

30. The method of claim 29 wherein the data object request includes the address of the second end device.

31. The method of claim 30 further including sending an information request from said data object server to said second end device requesting the device class of the second end device, and sending a response from the second end device to data object server including the device class of the second end device, wherein the data object server selects a communication program for transmission to the first end device based on the device class of the second end device.

32. The method of claim 31 wherein the data object request further includes the device class of the first end device and wherein the data object server selects a communication program based on the device class of the first and second end devices.

33. The method of claim 24 wherein communication program comprises one of an encoding/decoding program, cryptographic program; compression/decompression program; and digital rights management program.

34. The method of claim 24 wherein the communication program comprises a control program for controlling the second end device.

35. The method of claim 34 wherein the second end device comprises a game server and wherein the control program comprises a game program to interact with the game server to control a game executing on the game server.
